(19) United States
(12) Patent Application Publication
(10) Pub. No.: US 2009/0307910 A1
(43) Pub. Date: Dec. 17, 2009

(54) Conduit Saw

(76) Inventor: James Schlosser, Placitas, NM (US)

Correspondence Address: PEACOCK MYERS, P.C., 201 THIRD STREET, N.W., SUITE 1340, ALBUQUERQUE, NM, 87102, US

(21) Appl. No.: 12/484,022

(22) Filed: Jun. 12, 2009

Related U.S. Application Data
(60) Provisional application No. 61/061,063, filed on Jun. 12, 2008.

(51) Int. Cl. B23D 21/04; B26D 3/16

(52) U.S. Cl. 30/101; 83/54

(57) ABSTRACT

A method and apparatus for cutting conduit. The apparatus preferably comprises a motor operated cutting blade which is slideable relative to a fixture for holding the conduit. The fixture is preferably spring loaded and preferably sufficiently grips the conduit so that only one hand is needed to operate the saw and cut the conduit. Alternatively the conduit may be held by one hand while the saw is operated by the other hand. The saw is preferably cordless.

### CROSS-REFERENCE TO RELATED APPLICATIONS

This application claims priority to and the benefit of the filing of U.S. Provisional Patent Application Ser. No. 61/061,063, entitled “Conduit Saw,” filed on Jun. 12, 2008. The specification and claims of the aforesaid application are incorporated herein by reference.

### BACKGROUND OF THE INVENTION

### Field of the Invention (Technical Field)

The present invention relates to a preferably cordless device for cutting conduit, cable, pipe, or the like. The device is particularly useful for construction sites and is preferably operable using only one hand.

### SUMMARY OF THE INVENTION

The present invention is an apparatus for cutting conduit, the apparatus comprising a conduit holder comprising one or more spring loaded members and a motor-operated cutting blade moveable relative to the conduit holder. At least one of the members is preferably moveable to accommodate insertion of the conduit. The moveable member is preferably hinged with respect to a housing. A spring preferably forces the at least one member against the conduit, thereby securing the conduit between the at least one member and a second member. Each of the members preferably comprises a pliers-like grip. The at least one member optionally exerts force against the conduit in a direction substantially parallel to the direction of movement of the blade. At least one member preferably comprises an opening for accommodating relative movement of the blade. At least one member preferably comprises an opening for sighting a cutting mark on the conduit. At least one member is optionally curved for receiving the conduit. The apparatus preferably further comprises a stop for limiting movement of the blade relative to the conduit holder.

The present invention is also a method for cutting conduit, the method comprising the steps of inserting a conduit between two members, at least one member being spring loaded so as to exert a force against the conduit, moving a motor-operated blade relative to the conduit, and cutting the conduit. The inserting step preferably comprises moving the at least one member a distance sufficient to accommodate a diameter of the conduit. Moving the at least one member preferably comprises rotating one edge of the at least one member about a hinge. The method preferably comprises the step of securing the conduit between the two members. The force is optionally exerted in a direction substantially parallel to a direction of movement of the blade, in which case the method optionally further comprises the step of bracing at least one of the members against a surface prior to the moving step to prevent movement of the conduit in the direction of movement of the blade during the moving and/or cutting steps. The method preferably further comprises the step of viewing a cutting mark on the conduit through an opening in one of the members. The method preferably further comprises the step of stopping the movement of the blade relative to the conduit. The stopping step preferably comprises setting a position of a stop prior to the cutting step.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1A is a cutaway side view of an embodiment of the present invention before the conduit is inserted;

FIG. 1B is a cutaway side view of the embodiment of FIG. 1A with the conduit inserted;

FIG. 2 is a perspective view of the embodiment of FIG. 1A;

FIG. 3 shows two partial cutaway views of another embodiment of the present invention;

FIG. 4 is a cutaway view of another embodiment of the present invention; and

FIG. 5 is a see-through view of the embodiment of FIG. 4.

### DETAILED DESCRIPTION OF THE INVENTION

As used throughout the specification and claims, the term “conduit” means conduit, wire, cable, tubing, pipe, bar, rod, or any solid or hollow elongate object or stock. As used throughout the specification and claims, the term “cut” means to completely or partially nick, score, cut, or sever an object, and the like. As used throughout the specification and claims, the term “spring” means any device for accommodating movement which exerts a force in opposition to said movement, such as a spring, elastic band, compressive material, and the like.

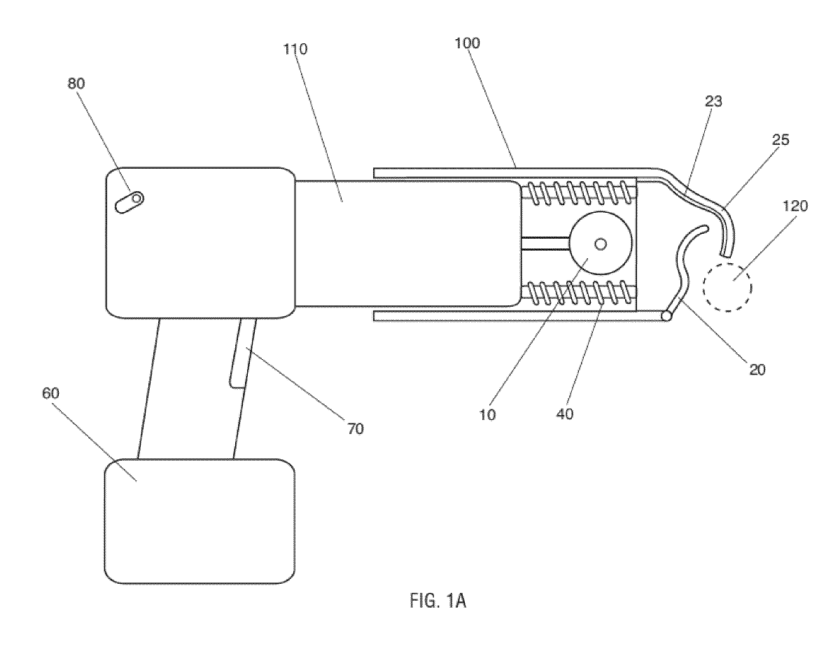

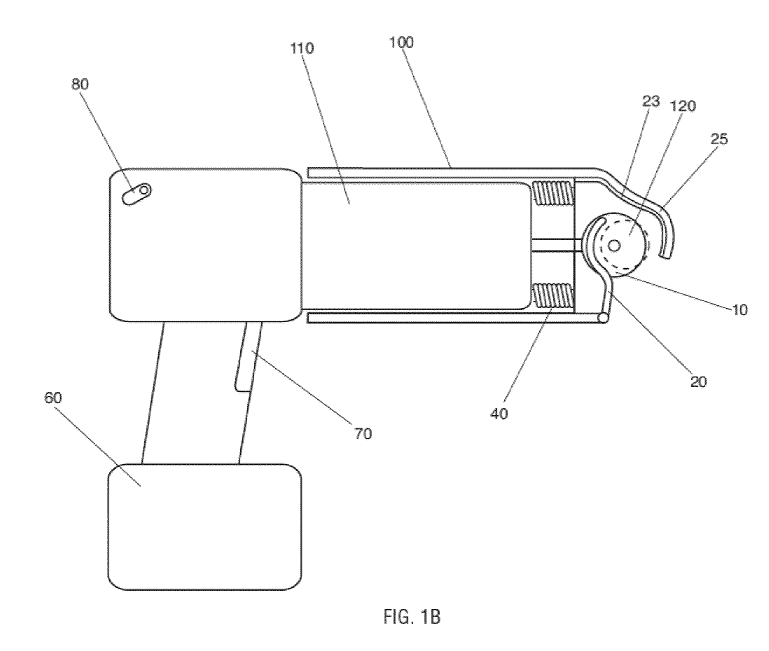

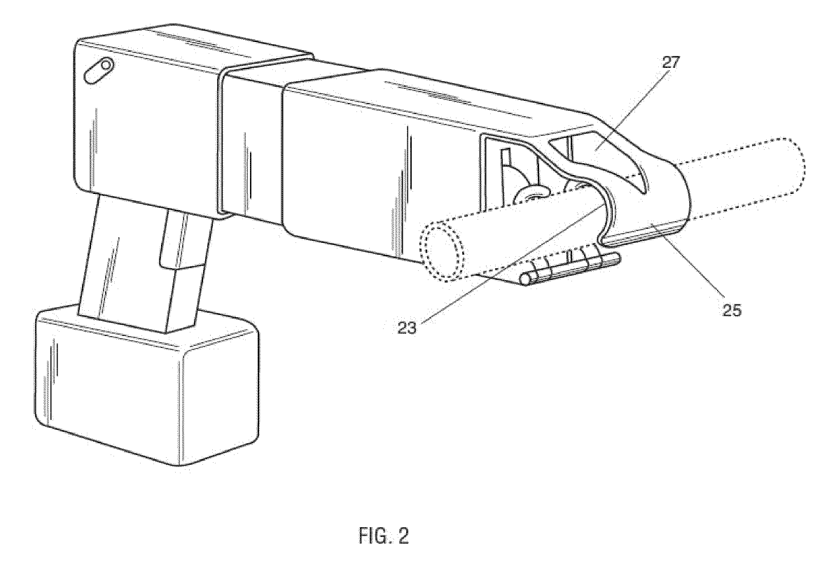

As shown in FIGS. 1A, 1B, and 2, an embodiment of the present invention preferably comprises cutting blade 10 preferably connected to housing body 110, which is slideable relative to stationary housing 100. Although cutting blade 10 is shown as rotary, any type of blade, such as a reciprocating blade, may alternatively be employed. A motor for driving cutting blade 10 is preferably powered by rechargeable battery 60, which is preferably located in the handle of the saw, but may be located anywhere.

In operation, conduit 120 is pushed against flap 20, which is preferably spring loaded. Once conduit 120 is inserted fully, flap 20 preferably exerts force against conduit 120, thereby securing conduit 120 against stationary housing 100 and conduit holder 25. Conduit holder 25 and flap 20 are preferably curved for receiving conduit 120 and are preferably attached to stationary housing 100. Conduit holder 25 and flap 20 may optionally be straight or angled, and may be specifically designed for use with a particular conduit type. Flap 20 preferably comprises prongs, or alternatively a groove or slot, for allowing cutting blade 10 to pass through in order to cut or score conduit 120. Conduit holder 30 preferably comprises opening 27 (such as a slot or groove) to allow user to view a cutting mark on conduit 120 in order to align the blade position with a cutting mark on the conduit. Each side of conduit holder 25 preferably comprises wall 23, which is approximately perpendicular to the front face of conduit holder 25, and which, when conduit 120 is inserted in the saw, prevent conduit 120 from contacting the inside face of conduit holder 25. This permits cutting blade 10 to cut entirely through conduit 120 without contacting conduit holder 25. Conduit holder 25 may alternatively comprise a plate with a groove, or alternatively comprise prongs, for accommodating the travel of cutting blade 10, and is optionally adjustable to accommodate a specific diameter of conduit 120.

Once the conduit is secured, the user preferably braces the front of conduit holder 25 against a hard surface, for example a stud or concrete floor, and the operator preferably actuates trigger 70, which activates cutting blade 10. The operator then pushes sliding housing body 110 relative to stationary housing 100. This forces cutting blade 10 to contact conduit 120, thereby preferably transversely scoring or cutting it, as desired by the operator, depending on the amount of movement imparted by the operator. The saw may optionally be designed with a stop, which is optionally adjustable, so that sliding housing body 110 can only slide a maximum distance relative to stationary housing 100. This allows a score or cut to be made at a repeatable depth. The operator may also, or alternatively, activate brake switch 80, preferably with a thumb, which then engages a brake, thereby limiting the travel of blade 10. One or more springs 40 preferably force sliding housing body 110 back to its original position relative to stationary housing 100 after the conduit is cut or scored. Once the conduit is cut, it preferably will fall out of the conduit holder without having to be released by the user.

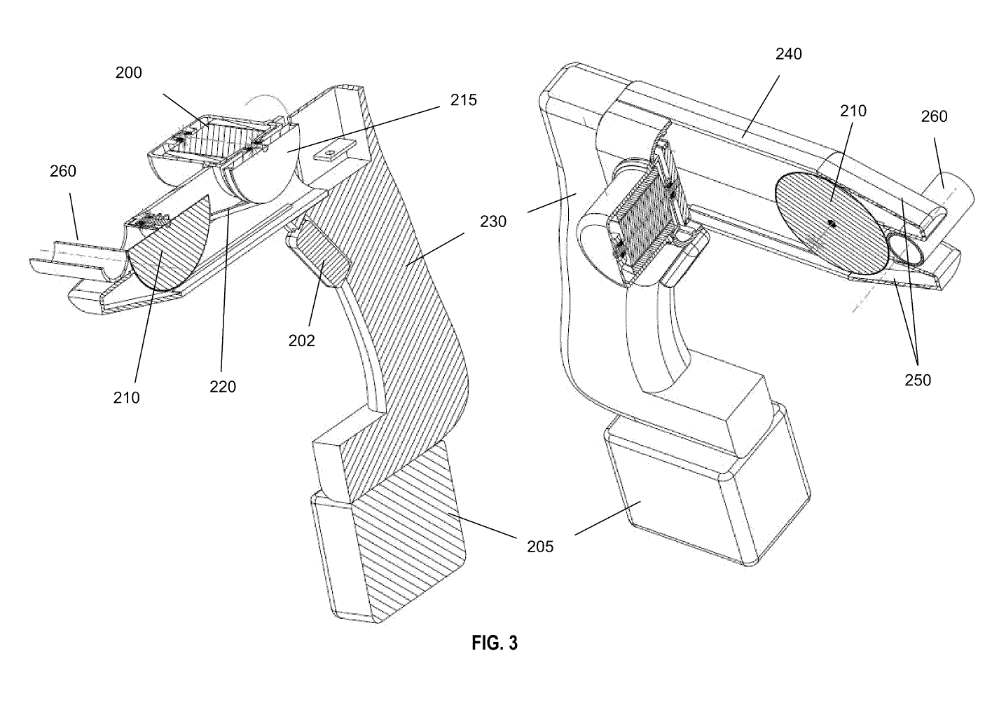

FIG. 3 shows two partial cutaway views of another embodiment of the present invention. The operation of this embodiment is similar to the previously described embodiment. Motor 200 is activated by trigger 202, is powered by battery 205, and drives blade 210 via pulley 215 and belt 220. The blade may alternatively be directly or otherwise driven by the motor without use of a belt. The motor and blade are preferably attached to handle 230 and is slideable relative to outer housing 240. Outer housing 240 comprises grips 250 for holding conduit 260. Grips 250 may optionally be smooth, grooved, patterned, textured, rubberized, or the like for holding conduit 260. Grips 250 are preferably split, or otherwise comprise an opening, for accommodating the blade as it travels. Grips 250 are preferably hinged and spring loaded with respect to outer housing 240 to automatically accommodate different diameters of conduit and to tightly grip conduit 260. Thus when a conduit is inserted into the grips, it preferably forces the grips apart until the conduit is sufficiently secured due to the force of the spring loaded grips against the conduit. The upper grip may comprise a window or notch or the like for sighting a cutting mark on the conduit.

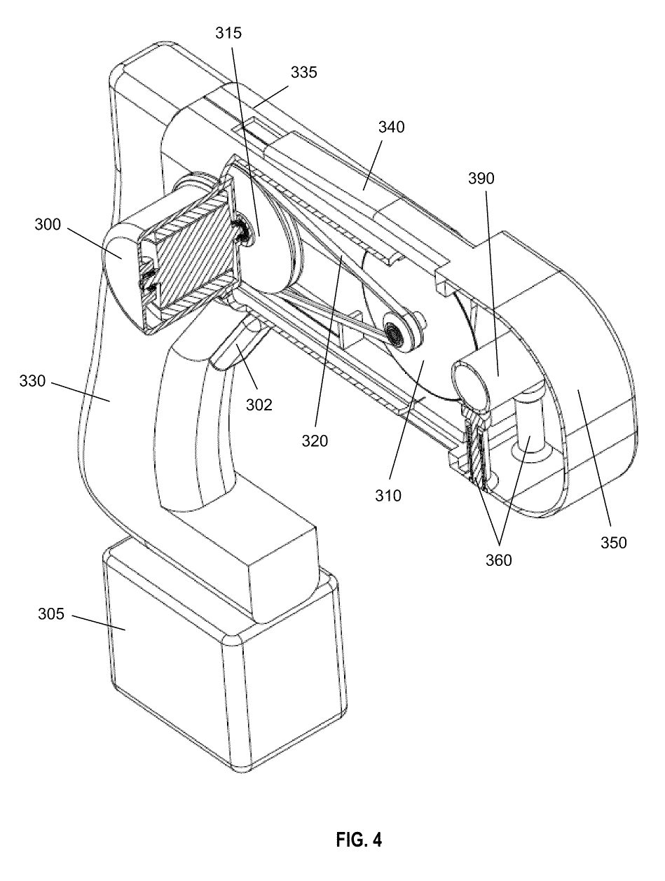

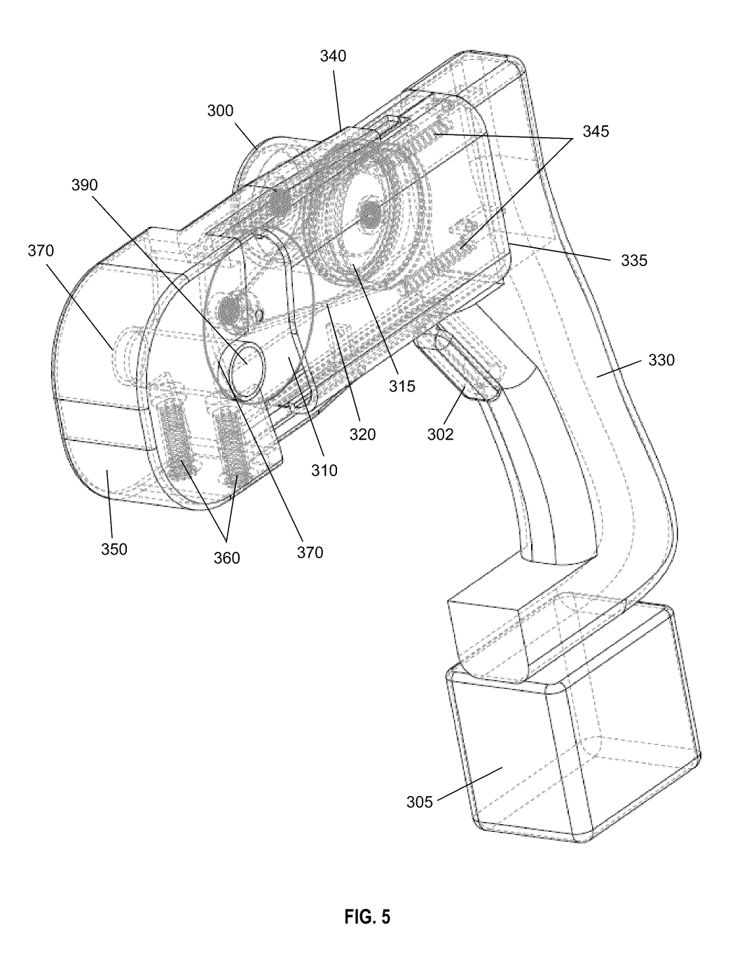

FIGS. 4 and 5 are cutaway and see-through views of another embodiment of the present invention. Referring to FIGS. 4 and 5, motor 300 is activated by trigger 302, is powered by battery 305, and drives blade 310 via pulley 315 and belt 320. The motor and blade are preferably attached to handle 330 and housing 335, which collectively are slideable relative to conduit housing 340. Housing 335 and conduit housing 340 are preferably attached via one or more springs 345 which serve to return the housings to their original relative positions after blade 310 finishes cutting conduit 390. Conduit housing 340 comprises conduit holder 350, which optionally comprises one or more spring loaded plungers 360. In this embodiment, an end of conduit 390 is inserted through cutouts 370 in conduit holder 350 and is supported in place by optional plungers 360. Once conduit 390 is secured in the desired position, the operator preferably braces conduit holder 350 against a surface, activates trigger 302, and thrusts handle 330 (and accordingly blade 310) forward relative to conduit holder 350, thereby cutting conduit 390.

The present invention may comprise any type or style of handle or grip, and is preferably operable with only one hand, thereby allowing the user to hold the conduit in place while it is being cut. The present invention may optionally be used to score wire or cable, such as ⅜″ metal cable, to enable easy stripping. Because the present invention doesn't require the conduit to rotate during the cutting process, it may be used to cut conduit which is already mounted or installed.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An apparatus for cutting conduit, the apparatus comprising:
a conduit holder comprising one or more spring loaded members; and
a motor-operated cutting blade moveable relative to said conduit holder.

2. The apparatus of claim 1 wherein at least one of said members is moveable to accommodate insertion of a conduit.

3. The apparatus of claim 2 wherein said moveable member is hinged with respect to a housing.

4. The apparatus of claim 2 wherein a spring forces said at least one member against the conduit, thereby securing the conduit between said at least one member and a second member.

5. The apparatus of claim 4 wherein each of said members comprises a pliers-like grip.

6. The apparatus of claim 4 wherein said at least one member exerts force against the conduit in a direction substantially parallel to a direction of movement of said blade.

7. The apparatus of claim 1 wherein at least one member comprises an opening for accommodating relative movement of said blade.

8. The apparatus of claim 1 wherein at least one member comprises an opening for sighting a cutting mark on the conduit.

9. The apparatus of claim 1 wherein at least one member is curved for receiving the conduit.

10. The apparatus of claim 1 further comprising a stop for limiting movement of said blade relative to said conduit holder.

11. A method for cutting conduit, the method comprising the steps of:
inserting a conduit between two members, at least one member being spring loaded so as to exert a force against the conduit;
moving a motor-operated blade relative to the conduit; and
cutting the conduit.

12. The method of claim 11 wherein the inserting step comprises moving the at least one member a distance sufficient to accommodate a diameter of the conduit.

13. The method of claim 12 wherein moving the at least one member comprises rotating one edge of the at least one member about a hinge.

14. The method of claim 11 further comprising the step of securing the conduit between the two members.

15. The method of claim 11 wherein the force is exerted in a direction substantially parallel to a direction of movement of the blade.

16. The method of claim 15 further comprising the step of bracing at least one of the members against a surface prior to the moving step to prevent movement of the conduit in the direction of movement of the blade during the moving and/or cutting steps.

17. The method of claim 11 further comprising the step of viewing a cutting mark on the conduit through an opening in one of the members.

18. The method of claim 11 further comprising the step of stopping the movement of the blade relative to the conduit.

19. The method of claim 11 wherein the stopping step comprises setting a position of a stop prior to the cutting step.
